(19) United States
(12) Patent Application Publication
(10) Pub. No.: US 2002/0075492 A1
(43) Pub. Date: Jun. 20, 2002

(54) Method to custom colorize type face

(76) Inventor: Brian Craig Lee, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/738,200

(22) Filed: Dec. 15, 2000

(51) Int. Cl. B41B 1/00; B41J 1/00; G06K 1/00; G06F 15/00

(52) U.S. Cl. 358/1.9

(57) ABSTRACT

PostScript® or TrueType® output font can be printed and displayed with varying colors through-out each character or letter so as to appear to be colorized differently. By manipulating the pixels of a polygon of a glyph that comprises a character or letter, different colors, lines or textures can be assigned to each constituent polygon. When the polygons are re-assembled, the resultant glyph can be made to appear to have different color components, textures or other characteristics.

### FIELD OF THE INVENTION

This invention relates to printing. In particular, this invention relates to a method by which rasterized images are created to have variable colorization.

### BACKGROUND OF THE INVENTION

Raster images are well known. In general, raster images include any sort of shape or character (letters and numbers) that is created by individual picture elements for output from a printer or display (CRT) device. Laser printers, ink jet printers and most computer displays are raster scan displays which create an output image by painting individual picture elements the assemblage of which creates a recognizable character or shape.

Text characters (letters and numbers) formed as raster images are routinely created for output on a printing device by computer programs such as word processors and the like. It is well-known to anyone using a commercial word processor that these programs enable a user to select an almost unlimited number of type faces in an unlimited number of type sizes for printing. The ease by which type face and type size is adjusted is accomplished through the use of “glyphs,” which simply put, are polygons that when combined together, form the shapes or outlines of characters or other images.

“Glyphs” are not new but are known to those skilled in the printing art and are disclosed in at least one publication. The Adobe Systems Incorporated publication of the “POSTSCRIPT Language Reference,” Third edition. Published by Addison-Wesley, copyright 1985-1999 by Adobe Systems Incorporated discloses “glyphs” as printing elements.

Characters, letters and many graphics images are formed from glyphs. By turning on the appropriate binary digits in a video graphic display, the glyphs that comprise a character, letter or other graphic image can be colorized or shaded with color or black.

Computer programs that produce printed output are capable of producing output with a variety of different properties. Many users of these programs want to be able to create eye-catching documents, in part, by using eye-catching typography.

A limitation of prior art typography however is that glyphs have been made to appear with a single characteristics, e.g. a single color or black. If the several glyphs of an image, or the individual components of a glyph could be colored or textured with other colors, the resultant output might produce a more eye-catching output, such as varying color type face.

### SUMMARY OF THE INVENTION

There is provided a method of producing variable-format output type fonts, including variable color, texture and/or patters. The method includes the step of decomposing a letter, number or other character to be printed into the constituent glyphs. To each of the constituent glyphs there can be added one or more distinguishable characteristics, such as black or other color or pattern. After a glyph, or at least one of its constituent elements is distinguished, a multi-piece character, i.e. one comprised of many glyphs, is reconstructed by combining the glyph pieces (if there is more than one) to form the original character. The resultant is a character, such as a letter, number or other symbol or image having a differently appearing color and/or texture, according to how the glyph pieces were transformed.

### BRIEF DESCRIPTION OF THE DRAWINGS

FIG. 1 shows a simplified representation of a PostScript® level 2 or level 3 or a TrueType® font glyph representing the letter “A”.

FIG. 2 shows various polygons comprising the “A”glyph of FIG. 1.

### DETAILED DESCRIPTION OF THE PREFERRED EMBODIMENT

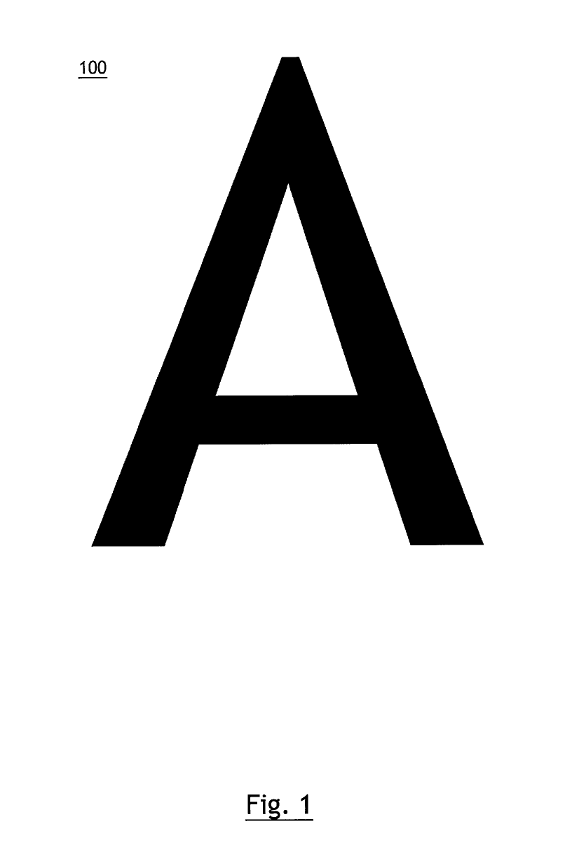

FIG. 1 shows a simplified representation of an Adobe Systems Incorporated PostScript® level 2 or level 3 or a TrueType® font glyph representing the letter “A” for use with PostScript® compatible printers, video displays and other such output devices. A PostScript®-compatible output device is a vector device and when its output is rasterized such devices include laser printers, dot-matrix printers, ink-jet printers, digital image setters and raster scan monitors. The defining property of a raster scan output device is that output images consist of individual dots or picture elements (also known as pixels), each of which can be individually addressed. Each pixel can be made black, white or a different color by manipulating the binary digits (bits) of a binary word assigned to represent the condition or state that each pixel is to be, from the output device.

Characters (letter and numbers) output from a PostScript® compatible device will be formed by a large number of pixels, which when output, are readily recognizable as such. Lines, circles and other abstract graphical elements and scanned images are rendered on a raster output device by a process known as scan conversion, which is a process by which the pixels required to render the abstract graphical element is identified mathematically. Scan conversion is outside the scope of this disclosure and an understanding of it is not required for an understanding of this disclosure. See the Adobe Systems Incorporated, PostScript® Language Reference, third edition for a discussion of raster images, scan conversion and PostScript® principles.

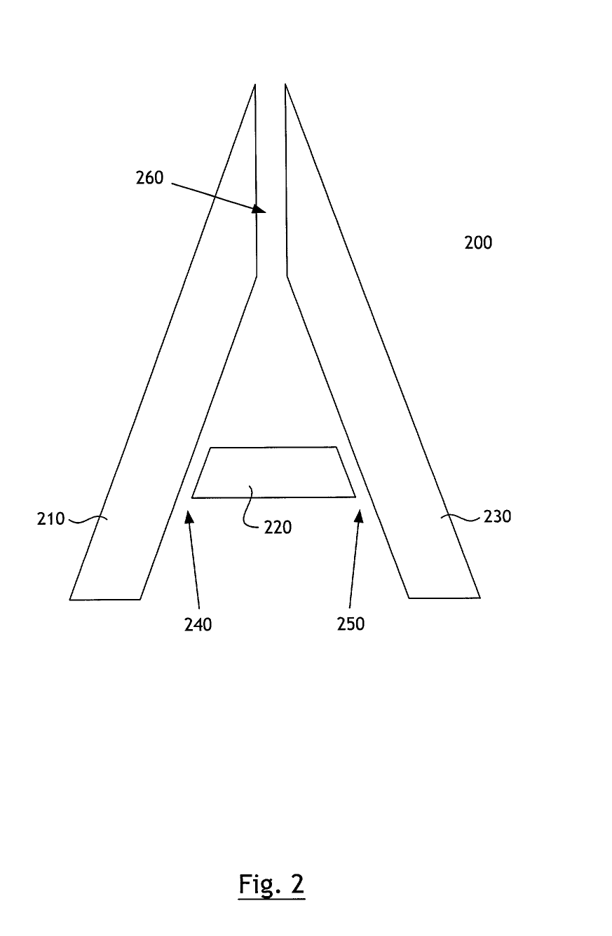

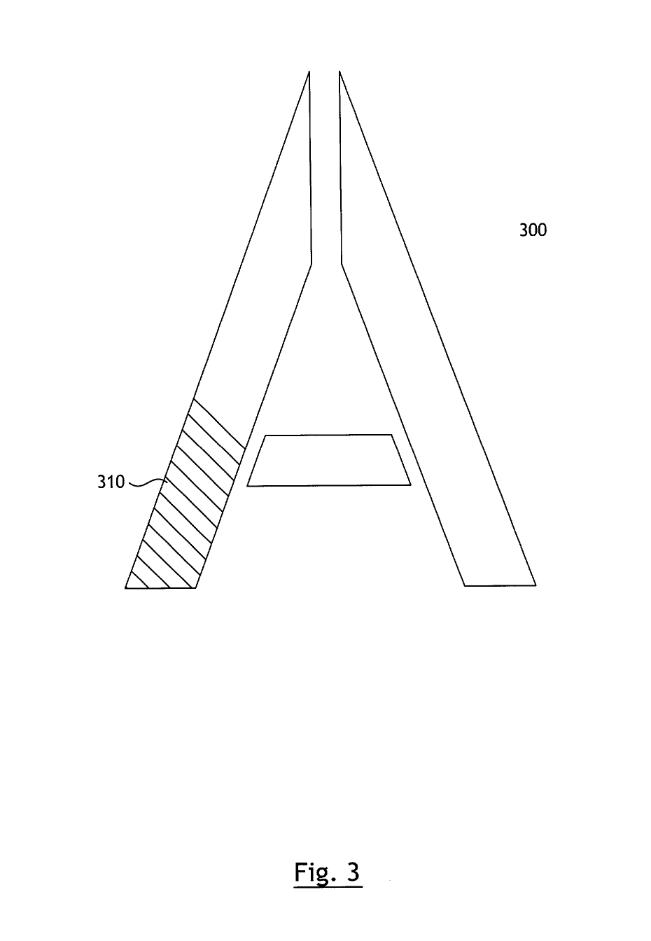

If the glyph of FIG. 1 is a PostScript® or TrueType® font, the parts of the glyph can be “separated” by either the user or a computer such that each of the constituent polygons can be treated separately prior to output on a display device. FIG. 2 shows the glyph of FIG. 1 decomposed or disassembled into three constituent polygons 210, 220, and 230. Each of the constituent polygons shown in FIG. 2 will be represented in memory by one or more memory locations, the bits of which are set or reset to control the appearance (color, pattern) of the polygon and therefore the glyph upon printing or display. A far more variable output can be realized by varying the color or pattern of the polygons 210, 220 and 230.

Byway of example, a computer printing program, or perhaps a printer driver program, can assign values to the bits corresponding to the pixels of the first polygon 210, binary values that are required to produce the first polygon 210 (from a PostScript® or TrueType® output device) in “red”. Similarly, the bits corresponding to the pixels of the second polygon 220 can be assigned values required to produce the second polygon (from a PostScript® or TrueType® output device) in a violet. Finally, the bits corresponding to the pixels of the third polygon can be assigned values to produce (from a PostScript® or TrueType® output device) the third polygon as blue. After the polygons 210, 220 and 230 are assigned the colors red, violet and blue respectively, they can be “re-assembled” in memory and sent to a PostScript® or TrueType® output device which will render the letter “A” that appears to be comprised of three different colors.

Different effects can be produced by further processing of the polygons 210, 220 and 230 as well as processing the intersections 240, 250 and 260 of the polygons. By way of example, the red, violet and blue colors assigned to the polygons 210, 220 and 230 can be made to appear to smoothly blend or transition if some of the pixel elements in each polygon that are proximate to the intersection regions 240, 250 and 260 are set to produce the color in the adjacent polygon. In such a scenario, some of the pixels in polygon 210 that are adjacent to the intersection area 240 would be set to “violet” while some of the pixels in polygon 220 adjacent to intersection area 240 are set to “red” so as to make the type face appear to be randomly colorized or pseudo-randomly colorized or even texturized. After so doing, the glyph formed by re-assembling the polygons 210, 220 and 230 would appear to make a smooth or nearly continuous transition from red to violet, at least in the region 240. A similar process in the intersection regions 250 and 260 would produce smooth color transitions from violet to blue in region 250 and red to blue in region 260.

In addition to assigning or changing colors of glyph polygons, each glyph part can be assigned (the pixel elements set) to display a pattern, (straight lines, cross-hatched lines, sinusoidal lines, etc. lines, dots et al.) which might be assigned by a user or a mathematical scheme or algorithm. FIG. 3 shows how a glyph 300, such as the one shown in FIG. 2 might be filled with a geometric pattern, line or other effect 310 to produce yet other output type faces. The determination of what colors or textures or patterns to assign to a glyph or the polygons of a glyph could be by way of a mathematical algorithm (sine wave, fractal, repeating pattern, etc) to make the output appear more unique. Similarly, the assignment of different-colored pixels through out the polygons or adjacent to the intersection areas 240, 250 and 260 or variant thereof might be according to a mathematical algorithm or function to create yet other special effects, all of which are, for claim construction purposes, considered to be a “characteristic” added to a glyph or constituent element thereof.

In addition to the foregoing novel print output that is capable using the disclosed methodology, there is yet another benefit that might be realized by the disclosed invention. Optical character readers (OCRs) are computer programs that “read” an optically scanned page and converts character images into ASCII text. An OCR takes as input, the image of a page of text that has been optically scanned by a scanner and then converts images of characters on the page that the software recognizes into an electronic file of ASCII characters. Optical character readers cannot recognize multi-colored type face as taught herein.

With the advent of the Internet, even books are being distributed via the web. A problem with electronically distributing copyrighted printed material is the ease by which it can be pirated by making unauthorized printed copies. An extra layer of protection against unauthorized printing of electronically distributed publication is provided by coloring type as disclosed herein. Optical character readers cannot accurately read and convert multi-colored type face into text. By using the disclosed method for colorizing the type face, at least some of the text of a copyrighted work of authorship, e-books (books and other material that can be printed from an electronic file) can be safely distributed and printed with at least some colorized type so as to prevent unauthorized re-printing after processing by an OCR.

From the foregoing, it is apparent the numerous different special effects can be added to a PostScript® or TrueType® font, or a scan-converted image so as to produce type face that is not only colorized but also pseudo-randomly colorized and texturized. By use of the foregoing method, PostScript® or TrueType® outputs can be made far more interesting to the eye and distinguishable from other prior art output.

What is claimed is:

1. A method of displaying type to be displayed on an output device comprised of the steps of:
decomposing a glyph to be displayed into constituent pieces;
adding a characteristic to at least one constituent piece of said glyph;
reconstructing said glyph by combining said at least one constituent piece of said glyph with other constituent pieces of said glyph.

2. The method of claim 1 wherein said step of adding a characteristic to at least one constituent piece of said glyph includes the steps of:
adding an addressable color to said at least one constituent piece of said glyph.

3. The method of claim 1 wherein the step of adding a characteristic to at least one constituent piece of said glyph includes the steps of:
adding a texture to said at least one constituent piece of said glyph.

4. The method of claim 1 wherein the step of adding a characteristic to at least one constituent piece of said glyph includes the steps of:
adding a pattern to said at least one constituent piece of said glyph.

5. The method of claim 1 further comprised of the step of:
smoothing intersections of said constituent pieces of said glyph after reconstructing said glyph by combining said at least one constituent piece of said glyph with other constituent pieces of said glyph.

6. A method of electronically distributing copyrighted printed material so as to inhibit unauthorized copying comprised of the steps of:
decomposing at least a portion of the text of said copyrighted printed material into glyphs;
adding a color characteristic to at least some of the constituent pieces of the glyphs of said portion of the text of said copyrighted printed material;
reconstructing said glyphs of said portion of the text of said copyrighted material by combining said at least some of the constituent pieces of the glyphs of said portion of the text of said copyrighted printed material.
